(19) United States
(12) Patent Application Publication
(10) Pub. No.: US 2014/0197758 A1
(43) Pub. Date: Jul. 17, 2014

(54) POWER SUPPLY WITH INTERFACE AND EMBEDDED CONFIGURATION INFORMATION

(71) Applicant: CREE, INC., Durham, NC (US)

(72) Inventor: Harald Thomas, Wolfratshausen (DE)

(73) Assignee: Cree, Inc., Durham, NC (US)

(21) Appl. No.: 13/742,800

(22) Filed: Jan. 16, 2013

(51) Int. Cl. G05F 3/02; H05B 37/02

(52) U.S. Cl. CPC G05F 3/02; H05B 37/02
USPC 315/297; 323/318; 315/307

(57) ABSTRACT

A power supply system may include power supply circuitry configured to power an output load, and a processor configured to generate configuration information that configures a remote device with the capability to control the power supply circuitry. The processor may also be configured to transmit the configuration information with a network interface to the remote device in response to a triggering event associated with the remote device. In response to receipt of the configuration information, the remote device may be configured to generate a control interface. A user of the remote device may control the power supply circuitry through the control interface.

### TECHNICAL FIELD

The present disclosure relates generally to power supplies, and more particularly to a power supply system that sends information to a remote device to configure the remote device to control power supply circuitry.

### BACKGROUND

Power supplies may be used in electronic applications to convert an input voltage to a desired output voltage to power an output load. Power supplies may be controlled by controlling an amount of voltage or current output by the power supply to power the output load. Some power supplies may include one or more switches, and the amount of current delivered to the output load may depend on control of the switches the switches.

Some solutions to control power supplies may include establishing a wired network connection and using a server remote to the power supply. However, these control solutions may be inflexible and costly. For example, power supplies used to light buildings that are controlled with wired network connections may require extra wiring throughout the building. Also, the network formed may be through servers located remotely from the room or building that is being lighted by the power supply. Additionally, where multiple power supplies are being controlled individually by protocol-based slaves using different protocols, the server may need to translate the different protocols. Also, electronic devices adapted to control the power supply may be specially manufactured or configured to control the power supply, thereby limiting the number of electronic devices that may control the power supply.

### BRIEF DESCRIPTION OF THE DRAWINGS

FIG. 1 shows a schematic diagram of an example communication system including a power supply system driving an output load and a remote device.

FIG. 1A shows a schematic view of an example remote device configured to display a control interface.

FIG. 2 shows a flow chart of an example method of a power supply system that provides configurations information to a remote device.

FIG. 3 shows a flow chart of an example method of a remote device that receives configuration information from a power supply system.

### DETAILED DESCRIPTION

The present disclosure describes a power supply system that is configured to transmit to a remote device configuration information that configures the remote device to control power supply circuitry. The power supply system may send the configuration information to the remote device when the power supply system determines that the remote device is within a communication range of the power supply system. Various communication messages may be communicated between the remote device and the power supply system during one or more wakeup, network discovery, association, handshaking, authentication, and/or authorization routines or processes, which may associate and/or authorize the remote device to be connected in a network with the power supply system, or otherwise enable the power supply system to communicate the configuration information to the remote device.

When the remote device receives the configuration information, the remote device may generate and/or display a control application, such as a control interface, that may generate and/or be used to generate control information to control the power supply circuitry. The remote device may transmit the control information to the power supply system, which the power supply system may process to control the power supply circuitry. The power supply circuitry may be configured to power one or more output loads. In some configurations, the control information may include a desired output state of the output loads. For example, the output loads may include one or more light sources, such as light emitting diodes (LEDs). The control information may include a desired output state of the light sources, such as a desired on/off state, a desired brightness, and/or a desired color.

The configuration information may be stored in memory of, or otherwise embedded in, the power supply system. In addition or alternatively, configuration generation information that is used to generate the configuration information may be stored or otherwise embedded in the memory of the power supply system. The power supply system may access the memory in order to generate the configuration information and/or transmit the configuration information to the remote device.

In some configurations, the configuration information may be in the form of a web application or include web page content. The power supply system may include a web page generation module, such as an integrated or an embedded web server, to generate the web page content. Upon receipt of the web page content, the remote device may generate and/or display a web page, which may be used by the remote device as a control interface to generate the control information. The web page may receive input indicative of a desired output state of the output loads, such as from a user of the remote device, which the web page may use to generate the control information.

The remote device may be an electronic device or apparatus that is considered remote to the power supply system. For example, the remote device may be a wireless or mobile computing device, such as a smart phone or a tablet PC, as examples. The remote device may be a general purpose device or an electronic device that is not specially configured and/or manufactured for controlling the power supply circuitry.

In some configurations, the remote device may temporarily store or cache the configuration information in order to display the control interface and/or process the control information. In alternative configurations, the configuration information may not be stored by the remote device. The control interface, such as a web page, may be created and/or displayed. For configurations where the configuration information is temporarily stored, when the remote device is finished controlling the power supply circuitry, the control interface may be terminated, and the configuration information used to create and/or display the control interface may be removed from storage of the remote device. In this way, any remote device with network connectivity and proper authorization with the power supply system may move to within a communication range of the power supply system and receive information to be configured to control the power supply circuitry.

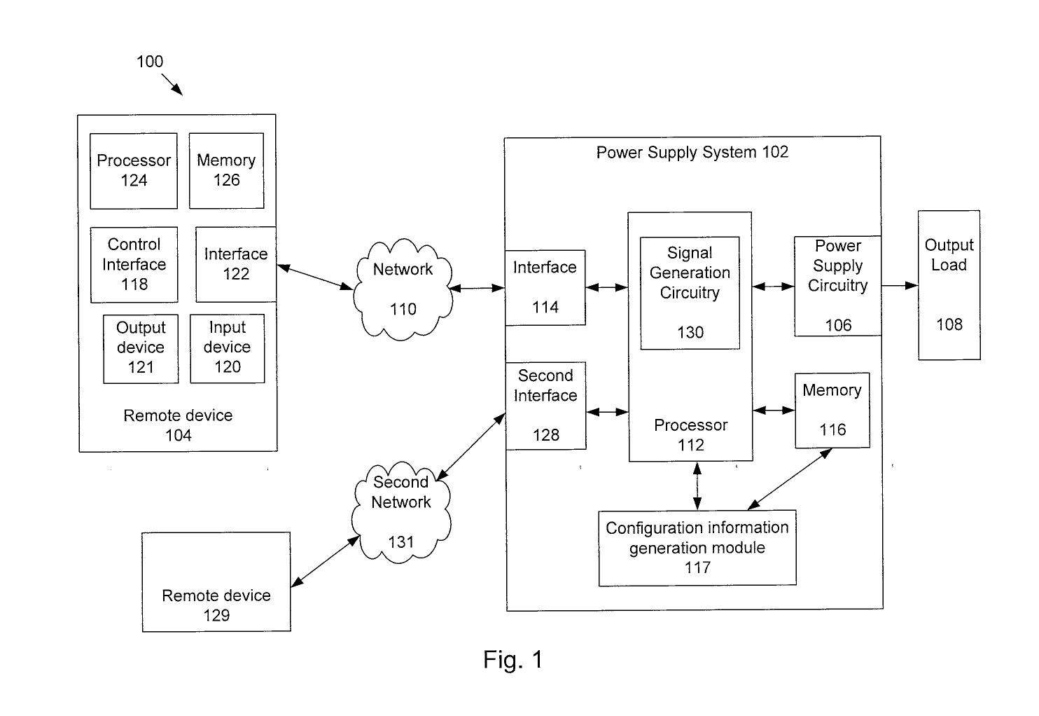

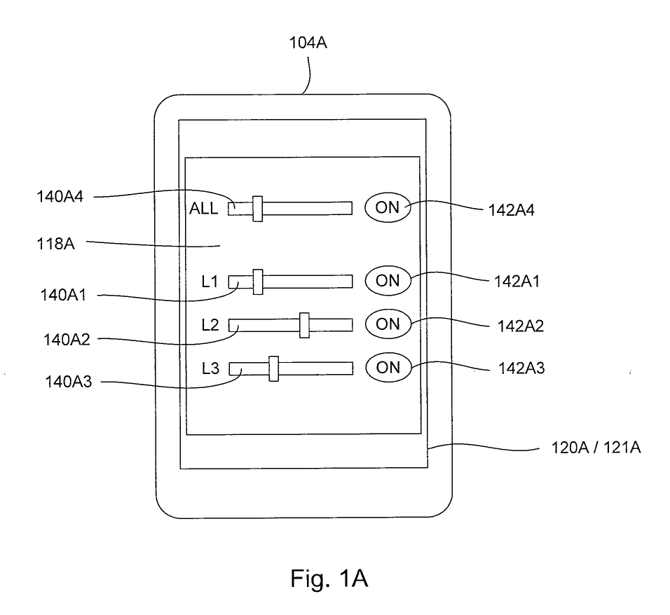

FIG. 1 shows an example system, such as a communication system, 100 that may include a power supply system 102 that may communicate configuration information to a remote device 104. The configuration information may configure the remote device 104 to control power supply circuitry 106 of the power supply system 102. The power supply circuitry 106 may be configured to power at least one output load 108. The configuration information may configure the remote device 104 with the ability to control the power that the power supply circuitry 106 supplies to the output load 108 in order to achieve a desired output or output state of the output load 108. For example, the output load 108 may include one or more light sources, such as one or more light emitting diodes (LEDs), and the configuration information may configure the remote device 104 with the ability to control the power supplied to the output load 108 in order to achieve a desired output state of the lights sources, such as an on/off state, a brightness, and/or a color output of the lights sources, as examples.

The power supply system 102 may be configured transmit the configuration information to the remote device 104 in response to a triggering event associated with the remote device 104. The triggering event may trigger or cause the power supply system 102 to generate the configuration information and/or transmit the configuration information to the remote device 104. The triggering event may include an identification or a detection of the remote device 104, a determination that the remote device 104 is within communication range of the power supply system 102, a determination that the remote device 104 wants to form a network connection, or combinations thereof. In addition or alternatively, the triggering event may include a determination that the remote device 104 wants to receive the configuration information from the power supply system 102. The power supply system 102 may determine the triggering event by communicating messages, such as pre-association messages, beacon messages, or probe messages, with the remote device 104. Various information may be included in the messages received by the power supply system 102 to identify the triggering event, such as information identifying the remote device 104, information identifying a distance away from the power supply system 102 (e.g., signal strength information), information indicating that the remote device 104 wants to form a network connection with the power supply system 102, and/or information that expressly specifies that the remote device wants to receive the configuration information.

In some configurations, the power supply system 102 may infer that the remote device 104 wants to receive the configuration information based on the messages received from the remote device 104. For example, if the power supply system 102 detects the presence of the remote device 104, detects that the remote device 104 is within a communication range or distance of the power supply system 102, or determines that the remote device 104 wants to form a network connection with the power supply system 102, the power supply system 102 may infer that the remote device 104 wants to receive the configuration information. In response to making the inference, the power supply system 102 may transmit the configuration information to the remote device 104.

Alternatively, the power supply system 102 may configured to receive messages that include information expressly indicating that the remote device 104 wants to receive the configuration information before sending the configuration information. For example, the power supply system 102 may be configured to transmit an inquiry message that inquires whether the remote device 104 wants to receive the configuration information. The power supply system 102 may transmit the inquiry message in response to detecting the remote device 104, determining that the remote device 104 is within a communication range of the power supply system 102, and/or determining that the remote device 104 wants to form a network connection with the power supply system 102. The remote device 104 may be configured to generate an inquiry response indicating that the remote device 104 wants to receive the configuration information. Based on the inquiry response, the power supply system 102 may determine whether to transmit the configuration information.

Upon determining that the remote device 104 wants to receive the configuration information, the power supply system 102 may transmit the configuration information to the remote device 104. Upon receipt of the configuration information, the remote device 104 may be configured to generate control information to control the power supply circuitry 106. The remote device 104 may transmit the control information to the power supply system 102, which may process the control information to control the power supply circuitry 106.

In some configurations, the power supply system 102 and the remote device 104 may establish a network 110 prior to the power supply system 102 transmitting the configuration information to the remote device 104. The network 110 may be established through a physical connection, such as a wired Ethernet connection, established wirelessly, or combinations thereof. The network 110 may be any type of network, such as a local area network (LAN), a wide area network (WAN), a personal area network (PAN), a piconet, an intranet, a virtual private network (VPN), an ad-hoc network, a cellular telephone network, or the Internet, as examples. The network 110 may be formed in accordance with any known or later developed network standards, such as Wi-Fi, Bluetooth, Institute of Electrical and Electronics Enginners (IEEE) 802.11, 802.16, 802.20, 802.1Q, WiMax, general packet radio service (GPRS), ZigBee, or Global System for Mobile Communications (GSM), as examples. Additionally, the network 110 may be formed using any known or later developed routines or techniques for the power supply system 102 and the remote device 104 to discover or detect each other to form the network 110, including those pertaining to network discovery, association, handshaking, and/or authentication, as examples. Various types of messages, such as probe messages or beacon messages, may be communicated between the power supply system 102 and the remote device 104 to form the network 110. In alternative configurations, the network 110 may not be formed between the power supply system 102 and the remote device 104 before the power supply system 102 transmits the configuration information and/or in order for the power supply system 102 to transmit the configuration information.

The power supply system 102 may include a processor 112 and an interface 114 in communication with the processor 112. The processor 112 may be configured to detect the remote device 104, determine when the remote device 104 moves to within communicate range of the power supply system 102, determine that the remote device 104 wants to form a network connection with the power supply system 102, and/or determine that the remote device 104 wants to receive the configuration information from the power supply system 102. The processor 112 may perform these functions by identifying or otherwise processing information or messages, such as the beacon or probe messages, received from the remote device, or by generating information or messages transmitted to the remote device 104. The processor 112 may transmit and/or receive the information and/or messages with the interface 114, such as through communication with the interface 114.

In response to the processor 112 detecting the triggering event, the processor 112 may determine to send the configuration information to the remote device 104. Before sending the configuration information and/or in response to the triggering event, the processor 112 may obtain and/or generate the configuration information. The power supply system 102 may include a memory 116 in communication with the processor 112 and/or the interface 114. In some example configurations, the power supply system 102 may be configured to store or embed the configuration information in the memory 116. In response to determining to transmit the configuration information to the remote device 104, the processor 112 may be configured to access the memory 116 to retrieve the configuration information. After retrieving the configuration information, the processor 112 may transmit the configuration information with the interface 114 to the remove device 104. Depending on the protocols used for the power supply system 102 to communicate with the remote device 104, additional processing, such as packetization and header generation, as examples, may be performed by the processor 112 to configure the configuration information for transmission to the remote device 104.

In addition or as an alternative to the configuration information being stored in the memory 116, the power supply system 102 may include a configuration information generation module 117 to generate the configuration information. Upon generation of the configuration information generation module 117, the configuration information may be stored in the memory 116 and/or transmitted by the processor 112 with the interface 114 to the remote device 104.

For clarity, FIG. 1 shows the configuration information generation module 117 as a component of the power supply system 102 that is separate from the processor 112 and the memory 116. However, the configuration information generation module 117 may be considered a component or part of the processor 112 and/or the memory 116, or that is stored or embedded within the processor 112 and/or the memory 116. In general, the configuration information generation module 117 may be implemented in hardware or a combination of hardware and software. The configuration information generation module 117 may be implemented using the processor 112, the memory 116, or combinations thereof. For example, the functions of the configuration information generation module 117 may be performed by the processor 112. In addition or alternatively, the configuration information generation module 117 may include software, a software application, computer executable instructions, and/or data representing computer executable instructions that may be stored in the memory 116 and executable by at the processor 116. Various configurations or implementations of the configuration information generation module 117 are possible.

The configuration information may include information that configures the remote device 104 with the ability or capability to control the power supply circuitry 106. In some configurations, without receiving the configuration information from the power supply system 102, the remote device 104 may not be configured or have the capability to control the power supply circuitry 106. To have the capability to control the power supply circuitry 106, the configuration information may configure the remote device 104 with the capability to generate and/or transmit control information, or control messages including the control information, to control the power supply circuitry 106. The control information may be indicative of a desired output or output state of the output load 108. To illustrate, the output load 108 may include a plurality of LEDs, and the control information may be indicative of a desired on/off state, brightness, and/or color output of the LEDs, as examples. Alternatively, the control information may be indicative of the power characteristics that the power supply generates or supplies to achieve the desired output state. For example, the control information may include information indicative of an amount of current to be supplied to each output load to generate a desired output.

The configuration information may also configure the remote device 104 to generate and/or display a control interface 118, such as a user interface. The control interface 118 may be configured to receive an input indicative of the desired output or output state of the output load 108. The input may be a user input of a user of the remote device 104. The input may be a tactile or an audio input, as examples. Alternatively, the input may be an electromagnetic signal, such as a radio frequency (RF) signal transmitted from another electronic device. In still alternative examples, the input may be from the surrounding environment, such as sunlight, audio, and/or temperature, as examples, that may be sensed by the remote device 104. Various types of inputs or combinations of inputs are possible.

In some example configurations, the control interface 118 may be a graphical interface, such as a graphical user interface (GUI), that includes a graphical display that may be displayed by the remote device 104. The GUI 118 may include various control features, such as input text boxes, check boxes, radio buttons, and/or slide bars, as examples, that may enable and/or be used by a user to enter the input.

In some example configurations, the power supply circuitry 106 may be configured to power multiple and/or different output loads 108 independently. For these configurations, the configuration information may provide the remote device 104 with the capability to generate different sets of control information for the different output loads 108. The control interface 118 may enable a user to control the different output loads 108 independently.

To illustrate, the output load 108 may include two different light sources, a first light source and a second light source, with each of the different light sources having its own output state, such as an on/off state, brightness, and/or color. The control interface 118 may provide the remote device 104 and/or a user of the remote device 104 with the ability to maintain an output state of first light source (e.g., keep the first light source “on”), and modify an output state of the second light source independent of the output state of the first light source (e.g., turn the second light source “off”), or set a first brightness for the first light source and a second brightness of the second light source. In addition or alternatively, the control information may include information that controls at least one but less than all of the output loads 108. For example, where the output load 108 includes a first light source and a second light source, the control information may include information that controls the output state of the first light source, but does not include information to control the output state of the second light source. Where multiple output loads are used, the control information may include identification information that identifies the output load to be controlled.

In some example configurations, the configuration information may include information indicative of a current output or a current output state of the output load 108. The remote device 104 may be configured to display or otherwise output the output state of the output load. In some example configurations, the current output state may be displayed as part of the control interface 118. The input to the remote device 104 may be an input that changes a current state of the output load 108.

To illustrate, the output load 108 may include a light source and, at the time the power supply system 102 transmits the configuration information to the remote device 104, the current on/off state of the light source may be “on”, and the configuration information may include information indicating that the light source is “on.” The control interface 118 may display or otherwise provide an output that the light source is “on.” For example, the control interface 118 may include a button push or a check box for the on/off state that is checked with a check mark to indicate that the light source is “on.” The input to the remote device 104 may then be an input that changes the on/off state of the light source from “on” to “off,” such as by removing the check mark from the box.

In addition or alternatively, the configuration information may include information indicative of a current state of the power supply circuitry 106, such as an amount of current or an amount of voltage being supplied to the output load 108. For example, if the power supply circuitry 106 is supplying current to a plurality of LEDs at the time the power supply system 102 transmits the configuration information, the configuration information may include information indicating the amount of current being supplied to each of the LEDs. The control interface 118 may display or otherwise provide an output indicating the amount of current that is being supplied. The input to the remote device 104 may then be an input that changes the current being supplied to one or more of the LEDs.

The remote device 104 may be implemented in hardware or a combination of hardware and software. The some example embodiments, the remote device 104 may be a mobile electronic device, such as a smart phone or a tablet personal computer (PC). In addition or alternatively, the remote device 104 may include one or more input devices 120 configured to receive a user input for the control interface 118, such as a keyboard, a joystick, a mouse, and/or a microphone as examples. The remote device 104 may also include one or more output devices 121, such as a display or speakers, that may be configured to display or otherwise output the control interface 118. In some example configurations, the input device 120 and the output device 121 may be integrated together as an input/output (I/O) device 120/121 that may both output the control interface 118 and receive inputs for the control interface 118. An example I/O device 120/121 may be a touchscreen that displays the control interface 118 and receives tactile inputs from a user of the remote device 104. The remote device 104 may also include a processor 124 that may communicate with the input device 120 and/or the output device 121 to generate, display, and/or receive inputs for the control interface 118.

In response to receipt of an input by the control interface 118, the processor 124 of the remote device 104 may be configured to generate the control information. In alternative configurations, the processor 124 may be configured to generate the control information without receipt of the input. The processor 124 may be configured to generate one or more control messages that include the control information and transmit the control messages to the power supply system 102. The processor 124 may transmit the control messages with an interface 124 that may communicate with the network 110. The processor 122 may also receive the configuration information with the interface 122 to generate and/or display the control interface 118.

In addition, the remote device 104 may include a memory 126 that may be configured to store the configuration information and/or any information generated or received as a result of receiving the configuration information (e.g., the control interface 118, the inputs, and/or the control information). In some example configurations, at least some of the information may be temporarily stored or cached in the memory 126. An amount of time that the information is stored may depend on a user session for controlling the power supply circuitry 106 with the remote device 104 and/or a user input. For example, upon receipt of the configuration information, the remote device 104 may store the configuration information in the memory 126. Information generated and/or received as a result of receiving the configuration information (e.g., the control interface 118, the inputs, and/or the control information), may also be stored in the memory 126. After a user of the remote device 104 is finished controlling the power supply circuitry 106, all or some of the information may be removed from the memory 126. In some configurations, the remote device 104 may determine that the user session has ended when the user closes out the control interface 118, such as through a user input to the input device 120. Alternatively or in addition, the remote device 104 may determine that the user session has ended when a period of time has elapsed without the control interface 118 receiving inputs. Various configurations are possible. If subsequent configuration information is then received by the remote device 104, the remote device 104 may be configured to temporarily store the subsequent configuration information in the memory 126.

In alternative example configurations, the processor 124 may communicate with the output device 121 to display the control interface 118 without storing or temporarily storing the configuration information and/or the control interface 118. In addition or alternatively, all or some of the inputs received by the control interface 118 may be converted into control messages without being stored in the memory 126. Various configurations are possible.

FIG. 1A shows a schematic view of an example remote device 104A, such as a smart phone or a tablet PC, that may be configured to display a control interface 118A to control power supply circuitry upon receipt of configuration information. The example remote device 104A shown in FIG. 1A may include a touch screen as an input/output (I/O) device 120A/121A to display the control interface 118A and receive inputs.

The example control interface 118A shown in FIG. 1A may be configured and/or include various control features or mechanisms to control output states of three light sources L1, L2, L3 independently, or all three light sources together (denoted by the “ALL” label). In some configurations, one or more of the light sources L1, L2, L3 may be light emitting diodes. Slide bars 140A1, 140A2, 140A3 may be associated with and control each of the light sources L1, L2, L3 respectively. In particular, the slide bars 140A1-A3 may control a brightness or a dimness for each of the light sources L1-L3. The slide bar 140A4 may control a brightness or dimness, or may brighten or dim the light sources L1-L3 together. The control interface 118A may also include ON/OFF buttons 142A1, 142A2, 142A3 associated with the light sources L1, L2, and L3, respectively. Inputs corresponding to the buttons 142A1, 142A2, 142A may toggle between “on” and “off,” which may turn each of the light sources “on” and “off” accordingly. Additionally, an ON/OFF button 142A4 may be used to turn all of the light sources L1-L3 “on” or “off.”

The control interface 118A shown in FIG. 1A is merely exemplary. Alternative control interfaces may include various features alternative or in addition to the features of the control interface 118A.

Referring back to FIG. 1, in some example configurations, the configuration information may include web content or web page content used to generate and/or display a web page. The web page content may be formatted using various language or protocols, such as hypertext markup language (HTML) or Java, as examples. The power supply system 102 may be configured to store or embed all or at least part of the web content in the memory 116. The processor 112 may be configured to access or retrieve the embedded web content and transmit the web content to the remote device 104. In addition or alternatively, the configuration information generation module 117 may be configured to generate, modify, and/or update all or at least part of the web content. In some example configurations, the configuration information generation module 117 may include an integrated web server or an embedded web server, such as an embedded hypertext transfer protocol (http) web server or a short message peer-to-peer (SMPP) web server, to generate the web content.

The processor 112, with the interface 114, may transmit the web content to the remote device 104. The remote device 104 may include a web browser that may be configured to receive the web content and display the web content as a web page, such as through the output device 121. The displayed web page may be the control interface 118 that receives inputs, such as through the input device 120. Based on the received inputs, the remote device 104 may generate the control information.

In some example configurations, upon receipt of the web content, the web content may be stored in the memory 126. In alternative example configurations, the web content may be displayed by the remote device 104 without being stored in the memory 126. Where the web content is stored, the web content may be temporarily stored or cached in the memory 126. For example, the web content may be stored or cached until no further inputs are received and/or a user is finished controlling the power supply circuitry 106. When the user is finished, the web page no longer be displayed by the output device 121, such as by an input received from the user to exit the web page, and the web content and/or information received and/or generated as a result of displaying the webpage, may be removed from the memory 126.

In this way, the web page provides a temporary control interface to control the power supply circuitry 106 for a remote device that is not specially configured or manufactured to control the power supply system 102, such as a smart phone, a tablet PC, or other mobile device. After the web page is exited, the remote device, such as the smart phone or tablet PC, may no longer have the capability to control the power supply circuitry 106 until other web page content is received from the power supply circuitry 102 and another web page is displayed by the remote device 104.

In some example configurations, the power supply system 102 may be configured to determine whether the remote device 104 is authorized to receive the configuration information before sending the configuration information to the remote device 104. The power supply system 102 may be configured determine whether the remote device 104 is authorized in response to determining that the remote device 104 is in communication range, that the remote device 104 wants to receive the configuration information, and/or that the network 110 is formed. In some example configurations, the power supply system 102 may determine whether the remote device 104 is authorized by transmitting an authorization request for login identification (ID) and/or password information. The login ID may identify the remote device 104 and/or a user of the remote device 104 that wants to receive the configuration information. The password may be used to authenticate the login ID. The authorization request may be include web content or other information that may cause the remote device 104 to generate and/or display a prompt to a user for a login and/or a password.

Upon receipt of the authorization request, the processor 124 of the remote device 104 may generate an authorization response that includes the requested information. In some example configurations, where the authorization request includes a request for a login ID and/or a password, the remote device 104 may be configured to output a prompt for the login and/or the password information to be input to the remote device 104. For example, the remote device 104 may display the prompt as a web page, and the login ID and/or a password may be input into the web page by a user of the remote device 104. In response to receiving the input, the processor 124 of the remote device 104 may generate the authorization response, including the inputted information, such as the login ID and/or password. Alternatively, the processor 124 may generate the authorization response automatically and/or without receiving a user input.

The processor 124, with the interface 122, may be configured to send the authorization response to the power supply system 102, such as by sending the authorization response over the network 110 to the interface 114 of the power supply system. The processor 112 may receive, with the interface 114, the authorization response, and may process authorization information, such as the login ID and/or the password, included in the authorization response to determine whether the remote device 104 is authorized to receive the configuration information. The determination may include a comparison of the authorization information with known or stored authorization information that identifies authorized remote devices and/or authorized users of one or more remote devices to control the power supply circuitry 106. For example, the processor 112 may compare a login ID and/or password received from the remote device 104 with known login ID and/or password information that may be included in a list of authorized login IDs and associated passwords. If the login ID and the password match an entry included in the list, then the processor 112 may determine that the remote device 104 is authorized to receive the configuration information. The list may identify multiple remote devices or multiple users of one or more remote devices that may receive the configuration information. The known authorization information identifying authorized remote devices and/or authorized users of remote devices may be stored in the memory 116 of the power supply system 102. The processor 112 may be configured to access or retrieve the known authorization information from the memory 116 to make the comparison. Alternatively, all or at least some of the known authorization information may be stored or located remotely from the power supply system 102, such as a remote storage unit or a remote server that may be accessed by the power supply system 102 through a wired or wireless connection. For example, the power supply system 102 may be configured to communicate over the network 110 or another network formed by the power supply system 102 using the interface 114 to access or retrieve the remotely stored authorization information.

Based upon the comparison, the processor 112 may determine whether the remote device 104 is authorized to receive the configuration information. If the processor 112 determines that the remote device 104 is authorized, the processor 112, with the interface 114, may be configured to transmit the configuration information to the remote device 104. Alternatively, if the processor 112 determines that the remote device 104 is not authorized or unauthorized, then the configuration information may not be sent to the remote device 104. In some example configurations, the power supply system 102 may communicate an unauthorization message to the remote device 104 if the processor 112 determines that the remote device 104 is not authorized. The unauthorization message may provide a notification to be output by the remote device 104 indicating that the authorization information provided by the remote device 104 is not valid. In addition or alternatively, the unauthorization message may include a request that authorization information be sent again by the remote device 104. Various configurations are possible.

In alternative example configurations, the power supply system 102 may determine that the remote device 104 is authorized during and/or as a result of formation of the network 110, such as through communication of security information and/or the use of encryption keys as examples. In response to the network 110 being formed, the power supply system 102 may determine that the remote device 104 is authorized to receive the configuration information without further communication of an authorization request for a login ID and/or password. As such, in response to formation of the network 110, the remote device may transmit the configuration information to the remote device 104.

In some example configurations, the power supply system 102 may include a second interface 128 in communication with the processor 112 and/or the memory 116. The second interface 128 may be configured to receive control information from a second remote electronic device or system that is external to the power supply system 102. The second interface 128 may communicate with the second external electronic device or system 129 through a wired or wireless connection and/or over a second wired and/or wireless network 131. In some configurations, the second interface 128 may be a serial interface or a serial port. In addition or alternatively, the power supply system 102 may be configured to communicate with the second remote device 129 over the second network 131, and/or the control information received by the second interface 128 may be formatted or configured in accordance with or using various standards, protocols, or connections, such as Digital Address Lighting Interface (DALI), DMX512, power line communication (PLC), KNX, or Ethernet as examples. Other standards or protocols may be used, including those that may be used to form the network 110 to communicate with the remote device 106, such as Wi-Fi, Bluetooth, IEEE 802.11, 802.16, 802.20, 802.1Q, WiMax, general packet radio service (GPRS), ZigBee, or Global System for Mobile Communications (GSM), as examples.

The processor 112 may be configured to receive the control information received from the second interface 128 and process the control information to control the power supply circuitry 106. In some example configurations, the processor 112 may be configured to use an interrupt or priority scheme to control the power supply circuitry 106 with control information received from both the interface 114 and the second interface 128. For example, control information received from the interface 114 may have a higher priority than control information received from the second interface 128. If the processor 112 is controlling the power supply circuitry 106 with control information received with the interface 114 and the second interface 128 receives other control information, the processor 112 may be configured to ignore the other control information or control the power supply circuitry 106 at a delayed time, such as at a time after the processor 112 is finished controlling the power supply circuitry 106 with the control information received with the interface 114. Alternatively, if the processor 112 is controlling the power supply circuitry 106 with control information received with the second interface 128, and the interface 114 receives other control information, an interrupt event may occur, in which the processor 112 may be configured to stop or cease controlling the power supply circuitry 106 with control information received with the second interface 128, and instead control the power supply circuitry 106 with the other control information received with the interface 114. The processor 112 may cease controlling the power supply circuitry 106 with the control information from the second interface 128 at various times, such as when the power supply system 102 detects that the remote device 104 is within communication range of the power supply system, determines that the remote device 104 wants to receive the configuration information, determines that the remote device 104 is authorized, forms the network 110 with the remote device 104, or receives the control information from the remote device 104. In alternative examples, the interrupt and/or priority schemes may be reversed—control information received from the second interface 128 may have a higher priority than control information received from the interface 114. Various configurations are possible.

The information communicated between the power supply system 102, the remote device 104, and/or remote device 129, including the configuration information, the control information, authorization requests and responses, information to form the networks 110 and/or 129, or any other information, may be formatted using any known or later developed message formats. For example, the information may be communicated as packets. The information may be packetized in any packet format and/or in accordance with any standard or protocol, such as Transmission Control Protocol (TCP) or User Datagram Protocol (UDP), as examples.

The power supply circuitry 106 may include any of various power supply or power converter topologies or configurations that may convert an input voltage to a desired output voltage to power the output load 108. The power supply circuitry 106 may perform various types of input-to-output conversions, including alternating current to direct current (AC-DC), DC-AC, DC-DC, or combinations thereof, as examples. In addition or alternatively, the power supply circuitry 106 may include linear power supply circuitry or switched-mode (or switching) power supply (SMPS) circuitry. The SMPS may have any of a number of various converter topologies or configurations, such as buck, buck-boost, boost, or flyback as examples. The power supply circuitry 106 may include various circuit components to perform the conversion and/or drive the output load 108, such as rectifier circuitry, charging circuitry (e.g., inductors), and/or switching circuitry (e.g., transistors), as examples. In addition or alternatively, the power supply circuitry 106 may be configured as a single-inductor-single-output (SISO) converter to power or drive a single output load, or alternatively as a single-inductor-multiple-output (SIMO) converter to power a plurality of output loads. In addition or alternatively, the power supply circuitry 106 may include a single converter, or multiple converters. For example, the power supply circuitry 106 may include two converter circuits to drive two output loads. Various configurations or topologies or combinations of configurations or topologies are possible.

The output load 108 may include an electronic device and/or electronic component or plurality of electronic devices and/or electronic components from which an output signal may be obtained and/or that may output an output signal. The loads may be active devices, passive devices, or a combination thereof. In addition or alternatively, the loads may be configured to conduct current, maintain a substantially constant voltage at an input terminal of the load, and/or function as a current sink. In addition or alternatively, the loads may be configured to generate energy and/or emit heat. Non-limiting examples include one or more light sources, such as solid state light emitters such as light emitting diodes (“LEDs”), cooling systems, motors, gear units, resistive and/or inductive actuators, zener diodes, linear circuitry, pulse-width-modulated (PWM) converters, resistors, capacitors, inductors, various other type of diodes, or any combination thereof. Various other types of output loads are possible.

In addition or alternatively, the output load 108 may include a plurality of output loads connected in series, connected in parallel, or a combination thereof. Where two or more output loads are connected in parallel, the output loads may be configured in output channels, where each output channel comprises one of the paths of the parallel connection. The power supply circuitry 106 may be configured to supply power to each output channel independent of the other output channels. For each output channel, the output load in the output channel may be connected in series with an output switch of the power supply circuitry 106 that is configured to switch between an “on” state and an “off” state. Control of the output switches may control the flow of current through each of the output channels.

As an example, the output load 108 may be configured to produce a light output that has three components—a red component, a green component, and a blue component. The output load 108 may include three output channels, where each output channel generates one of the components of the light output. A first channel may include one or more LEDs to produce the red component of the light output, a second channel may include one or more LEDs to produce the green component of the light output, and a third channel may include one or more LEDs to produce the blue component of the light output. The amount of current flowing through each of the output channels may yield a certain light output. Output switches may be connected in series with the LEDs in the output channels to control the amount of current through each output channel in order to produce a desired light output.

The processor 112 may be configured to control the power supply circuitry 106 to produce a desired output of the output load 108. For example, the processor 112 may be configured to control switching of one or more switches in the power supply circuitry 106 to control an amount of current being delivered to the output load 108 and/or drawn through each of the output channels. In some example configurations, the processor 112 may include, or be in communication with, at least one signal generator or signal generation circuitry 130. The signal generation circuitry 130 may be implemented in hardware, software, or a combination thereof. FIG. 1 shows the signal generation circuitry 130 as a component of the processor 112. In alternative example configurations, the signal generation circuitry may considered a component that is separate from the processor 112. Various configurations are possible. The signal generation circuitry 130 may be configured to generate and/or communicate switching signals that control the switching of switches in the power supply circuitry 106. In some examples configurations, the switching signals may include pulse-width modulated (PWM) signals that have an associated duty cycle, although other types of switching signals may be used. Based on the control information received from the interface 114 and/or the second interface 128, the processor 112 may control when the signal generation circuitry 130 generates and/or transmits the switching signals to switches in the power supply circuitry 106, and/or the duty cycles of the switching signals.

In some example configurations, the processor 112 includes a single processing device that is configured to receive control information from the interface 114 and/or the second interface 128, and is also configured to control the signal generation circuitry 130. In alternative example configurations, the processor 112 may include multiple processors, such as a first processor and a second processor (or a first plurality of processors and a second plurality of processors) that perform different functions. The first processor may be configured to receive and process control information received from the interface 114 and/or the second interface 128 and to generate the configuration information communicated to the remote device 104. The second processor may be configured to control the signal generation circuitry 130. For these configurations, the first processor may communicate with the second processor so that the second processor controls the signal generation circuitry 130 to produce a desired output by the output load 108 in accordance with the control information received by the first processor.

Each of the processor 112 of the power supply system 102 and the processor 124 of the remote device 104 may include a general processor, a digital signal processor, a microprocessor, a controller, a microcontroller, an application specific integrated circuit, a field programmable gate array, an analog circuit, a digital circuit, combinations thereof, or other now know known or later developed processors. In addition, each of the processors 112 and/or 124 may include a single processor, multiple processors, a single device or a combination of devices, such as associated with a network or distributed processing. Any of various processing strategies may be used, such as multi-processing, multi-tasking, parallel processing, remote processing, or the like. In addition or alternatively, each of the processors 112 and/or 124 may be responsive to and/or configured to execute instructions stored as part of software, hardware, integrated circuits, firmware, micro-code, or the like.

The memory 116 of the power supply system 102 and/or the memory 126 of the remote device 104 may each be non-transitory computer readable storage media. The computer readable storage media may include various types of volatile and non-volatile storage media, including but not limited to random access memory, read-only memory, programmable read-only memory, electrically programmable read-only memory, electrically erasable read-only memory, flash memory, magnetic tape or disk, optical media, and the like. The memory 116 and/or 126 may be a single device or a combination of devices. The memory 116 and/or 126 may be adjacent to, part of, networked with and/or remove from the processor 112 and/or the processor 124. Logic encoded in one or more tangible media for execution is defined as the instructions that are executable by the programmed processor and that are provided on the computer-readable storage media, memories, or a combination thereof.

The memory 116 and/or 126 may be a computer readable storage media having stored therein data representing instructions executable by the programmed processor. The memory 116 and/or 126 may store instructions for the processor. The processor 112 and/or 124 may be programmed with and execute the instructions. The functions, acts, methods, or tasks illustrated in the figures or described herein are performed by the programmed processor executing the instructions stored in the memory. The functions, acts, methods or tasks are independent of the particular type of instructions set, storage media, processor or processing strategy and may be performed by software, hardware, integrated circuits, firmware, micro-code, and the like, operating alone or in combination. The instructions are for implementing the processes, techniques, methods, or acts described herein.

Additionally, the interface 114 and the second interface 128 of the power supply system 102, and the interface 122 of the remote device 104 may each include one or more input/output (I/O) interfaces or I/O ports that may be used to communicate with the various components in the system 100. The interfaces 114, 122, 128 may be a network interface and/or implemented in hardware, such as a hard-wired or wireless network interface. The interfaces 114, 122, 128 may be a universal asynchronous receiver/transmitter (UART), a parallel digital interface, a software interface, Ethernet, or any combination of known or later developed software and hardware interfaces.

The power supply system 102 may further include one or more AC inputs 132 that may be configured to receive an AC signal, such as a 120 volt or a 220-240 volt AC power supply signal received from a power distribution system or device, which may include a wall outlet or wall plug. The AC input may be configured to communicate the received AC signals to the power supply circuitry 106, where the AC signals may be rectified or otherwise converted to drive the output load 108.

The electronic component of the power supply system 102 may be housed or integrated in a single housing or “box” or alternatively, multiple housings. Additionally, the power supply system 102 may be part of various mechanical structures associated with the output load 108. For example, where the output load 108 includes a light source, the power supply system 102 may be part of a light fixture. The light source may be used to provide lighting for any of a variety of lighting applications, such as those used to light any types of lighted areas, such as rooms, floors, levels, office buildings, residential buildings, shopping areas, stadiums, or arenas, as examples. The power supply system 102 may be implemented or integrated for use with any of these lighted areas. Additionally, the power supply system may provide configuration information to a remote device that enters into a lighted area so that the remote device is able to control the lighting for that lighted area. Various configurations or combinations of configurations are possible.

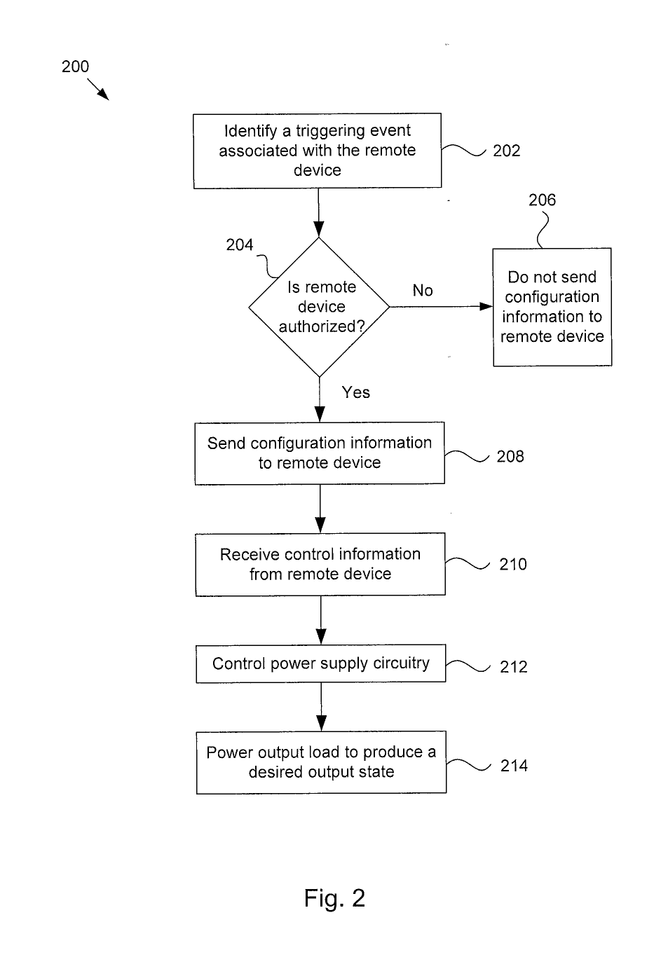

FIG. 2 shows a flow chart of an example method of a power supply system that provides configurations information to a remote device so that the remote device is configured with the ability to control the power supply system. At block 202, the power supply system identifies a triggering event associated with the remote device that triggers the power supply system to transmit the configuration information. For example, the power supply system may determine that a remote device wants to receive the configuration information, identify that the remote device is within a communication range of the power supply system, wants to form a network connection with the power supply system, or receives information from the remote device indicating that the remote device wants to receive the configuration information.

At block 204, the power supply system may determine whether the remote device is authorized to receive the configuration information. As described above, the power supply system may determine that the power supply system is authorized by receiving acceptable login ID and password information. If the power supply system determines that the remote device is not authorized, then at block 206 the power supply system may determine not to send the configuration information to the remote device. Alternatively, if the power supply system determines that the remote device is authorized, then at block 208 the power supply system may determine to send the configuration information to the remote device. In some configurations, to send the configuration information, the power supply system may first generate the configuration information and/or retrieve the configuration information stored in memory. The memory may be part of the power supply system, or alternatively may be external to the power supply system.

At block 210, the power supply system may receive control information from the remote device. The control information may be indicative of a desired output state of an output load, and/or indicative of a desired power setting of power supply circuitry used to drive the output load.

At block 212, the power supply system may control the power supply circuitry using the control information received from the remote device. In some configurations, the power supply circuitry may use the control information to control signal generation circuitry that generates switching signals to control switches in the power supply circuitry. In addition or alternatively, the power supply circuitry may use the control information to control other components of the power supply system. For example, based on the control information, the power supply circuitry may power itself down or shut itself off.

At block 214, the power supply circuitry may power the output load in accordance with the control information to produce a desired output state of the output load. For example, where the output load includes a light source, the power supply may power the light source to produce a desired light output, such as a desired on/off state, color and/or brightness.

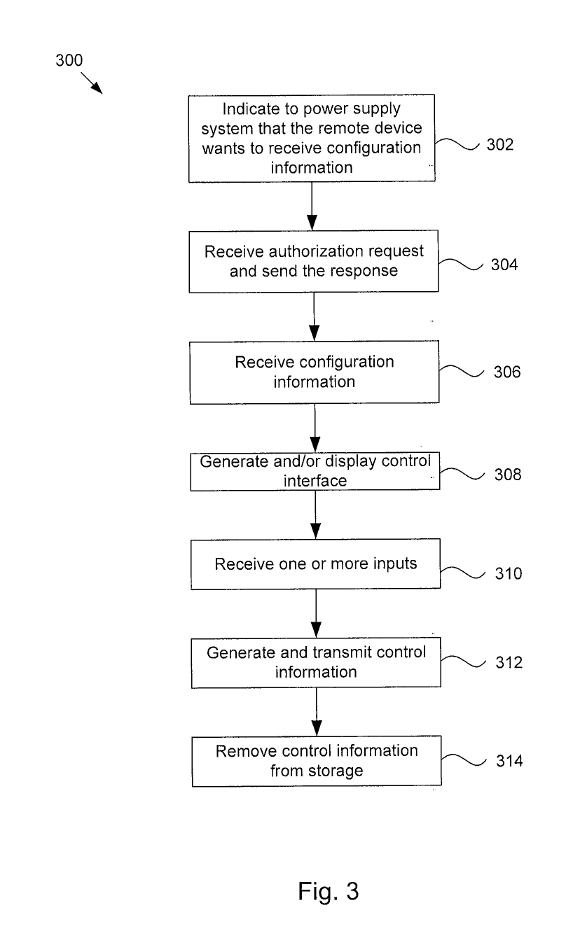

FIG. 3 shows a flow chart of an example method of a remote device that receives configuration information from a power supply system that configures the remote device with the ability to control the power supply system. At block 302, the remote device indicates to the power supply system that remote device wants to receive the configuration information. The remote device may do so by sending one or more messages, such as beacons, indicating that the remote device is within communication range of the remote device, form a network connection with the remote device, and/or transmit a message to the remote device indicating that the remote device wants to receive the configuration information.

At block 304, the remote device may receive an authorization request from the power supply system. The remote device may send an authorization response, which may include the requested information, such as a login ID and/or password. Before sending the authorization response, the remote device may generate an audio or visual prompt to a user for the authorization information. The remote device may then generate the authorization response based on the input received from the user. Alternatively, the remote device may generate the authorization response without receiving input from a user.

At block 306, the remote device may receive the configuration information from the power supply system. At block 308, upon receipt of the configuration information, the remote device may generate and/or display a control interface that may receive one or more inputs to control the power supply system. In some examples, the configuration information may include web content. Upon receipt of the web content, the remote device may display a web page to a user of the remote device. In addition, at block 308, the remote device may temporarily store or cache the configuration information, in that the configuration information may no longer be stored by the remote device once a user of the remote device is finished using the control interface.

At block 310, the control interface may receive one or more inputs, which may be indicative of a desired output state of an output load powered by the power supply system, and/or which may be indicative of a desired power setting of the power supply system. The inputs may be received by receiving information entered into the webpage and/or by identifying a modification of the web page, such as identifying movement of a slide bar.

At block 312, the remote device may generate control information used to control the power supply circuitry of the power supply system that drives the output load. Additionally, the remote device may transmit the control information to the power supply system. At block 314, the remote device may remove the configuration information from storage after a control session for controlling the power supply system has ended.

Various embodiments described herein can be used alone or in combination with one another. The foregoing detailed description has described only a few of the many possible implementations of the present invention. For this reason, this detailed description is intended by way of illustration, and not by way of limitation.

I claim:

1. A power supply system:
power supply circuitry configured to power an output load;
a network interface; and
a processor in communication with the network interface, the processor configured to:
generate configuration information that configures a remote device to control the power supply circuitry; and
transmit the configuration information with the network interface to the remote device in response to a triggering event associated with the remote device.

2. The power supply system of claim 1, wherein the processor is further configured to identify the triggering event by a determination that the remote device is within a communication range of the power supply system.

3. The power supply system of claim 1, wherein the processor is further configured to identify the triggering event by a determination that the remote device wants to form a network connection with the power supply system.

4. The power supply system of claim 1, wherein the processor is further configured to identify the triggering event by a determination that the remote device wants to receive the configuration information.

5. The power supply system of claim 1, wherein the processor is further configured to:
determine that the remote device is authorized to control the power supply circuitry; and
transmit the configuration message to the remote device in response to determination that the remote device is authorized.

6. The power supply system of claim 1, wherein the processor is further configured to receive control information with the network interface from the remote device to control the power supply circuitry.

7. The power supply system of claim 6, wherein the processor is further configured to control the power supply circuitry based on the control information.

8. The power supply system of claim 6, wherein the processor is configured to control signal generation circuitry based on the control information, the signal generation circuitry configured to output switching signals to control the power supply circuitry.

9. The power supply system of claim 1, wherein the output load comprises a light source; and wherein the configuration information configures the remote device to control at least one of: an on/off state of the light source, a brightness of the light source, or a color output of the light source.

10. The power supply system of claim 1, wherein the configuration information configures the remote device to display a control interface configured to receive a user input to control the power supply circuitry.

11. The power supply system of claim 10, wherein the user input is indicative of a desired output state of the output load.

12. The power supply system 10, wherein the configuration information comprises information indicative of a current state of the output load, and wherein the user input comprises information to change the current state of the output load.

13. The power supply system of claim 1, wherein the configuration information comprises web content that configures the remote device to display a web page as a control interface to control the power supply circuitry.

14. The power supply system of claim 13, further comprising an integrated web server used by the processor to generate the web content.

15. The power supply system of claim 1, wherein the configuration information comprises information to be temporarily stored by the remote device.

16. The power supply system of claim 1, wherein the configuration information comprises information to be stored by the remote device until a user session to control the power supply circuitry has ended.

17. The power supply system of claim 1, further comprising:
a memory in communication with the processor, the memory configured to store the configuration information, and wherein the processor is further configured to:
access the configuration information stored in the memory when the remote device is within communication range of the power supply system.

18. The power supply system of claim 1, wherein the power supply circuitry comprises switched-mode power supply circuitry.

19. The power supply system of claim 1, wherein the power supply circuitry comprises a single-inductor-single-output (SISO) converter.

20. The power supply system of claim 1, wherein the power supply circuitry comprises a single-inductor-multiple-output (SIMO) converter.

21. The power supply system of claim 1, wherein the output load comprises one or more light emitting diodes.

22. The power supply system of claim 1, wherein the interface comprises a wireless network interface configured to wirelessly transmit the control information over a network to the remote device.

23. A method of providing a remote device with capability to control power supply circuitry of a power supply system configured to drive an output load, the method comprising:
identifying, with a processor of the power supply system, a triggering event associated with a remote device; and
transmitting, with the processor, configuration information to the remote device in response to identifying the triggering event, the configuration information configuring the remote device to control the power supply circuitry.

24. The method of claim 23, wherein identifying the triggering event comprises determining, with the processor, that the remote device is within a communication range of the power supply system.

25. The method of claim 23, wherein identifying the triggering event comprises determining, with the processor, that the remote device wants to form a network connection with the power supply system.

26. The method of claim 23, wherein identifying the triggering event comprises determining, with the processor, that the remote device wants to receive the configuration information.

27. The method of claim 23, further comprising:
determining, with the processor, that the remote device is authorized to control the power supply circuitry; and
wherein transmitting configuration information comprises transmitting, with the processor, the configuration information to the remote device in response to determining that the remote device is authorized.

28. The method of claim 23, further comprising:
receiving, with the processor, control information from the remote device to control the power supply circuitry.

29. The method of claim 28, further comprising:
controlling, with the processor, the power supply circuitry based on the control information.

30. The method of claim 29, wherein controlling the power supply circuitry comprises controlling, with the processor, signal generation circuitry based on the control information, the signal generation circuitry configured to output switching signals to control the power supply circuitry.

31. The method of claim 29, wherein the output load comprises a light source, and wherein controlling the power supply circuitry comprises controlling, with the processor, the power supply circuitry to generate a desired output state of the light source, wherein the desired output state of the light source comprises at least one of: an on/off state of the light source, a brightness of the light source, or a color output of the light source.

32. The method of claim 23, wherein the configuration information comprises information to generate a control interface configured to receive a user input to control the power supply circuitry.

33. The method of claim 32, wherein the user input is indicative of a desired output state of the output load.

34. The method of claim 32, wherein the configuration information comprises information indicative of a current state of the output load, and wherein the user input comprises information that changes the current state of the output load.

35. The method of claim 23, wherein the configuration information comprises web content to generate a web page configured to receive an input to control the power supply circuitry.

36. The method of claim 23, wherein the configuration information comprises information to be temporarily stored by the remote device.

37. The method of claim 23, wherein the configuration information comprises information to be stored by the remote device until a user session to control the power supply circuitry has ended.

38. The method of claim 23, further comprising:
storing, with a memory, the configuration information; and
accessing, with the processor, the configuration information stored in the memory in response to identifying the triggering event.

39. The method of claim 23, wherein the interface comprises a wireless network interface, the method further comprising:
forming, with the processor, a wireless network with the remote device, and wherein transmitting the configuration information comprises wirelessly transmitting the configuration information over the wireless network to the remote device.

40. An electronic device remote to a power supply system, the electronic device comprising:
a network interface;
a processor in communication with the network interface, the processor configured to:
transmit a message to the power supply system with the network interface, the message indicating that the electronic device wants to receive configuration information to control power supply circuitry of the power supply system, the power supply circuitry configured to power an output load; and
receive the configuration information with the network interface.

41. The electronic device of claim 40, wherein the processor is further configured to generate a control interface upon receipt of the configuration information.

42. The electronic device of claim 41, wherein the control interface comprises a web page configured to receive a user input indicative of a desired output, state of the output load.

43. The electronic device of claim 42, wherein the output load comprises a light emitting diode, and wherein the web page comprises one or more control features to control an output state of the light emitting diode.

44. The electronic device of claim 43, wherein the one or more control features comprises at least one of a slide bar to control a brightness of the light emitting diode or a button to control an on/off state of the light emitting diode.

45. The electronic device of claim 41, wherein the processor is configured to generate control information to control the power supply circuitry in response to a user input to the control interface.

46. The electronic device of claim 40, further comprising:
a memory configured to store the configuration upon receipt of the configuration information; and
delete the configuration information after a user session controlling the power supply circuitry has ended.
